(19) United States
(12) Patent Application Publication
(10) Pub. No.: US 2009/0047470 A1
(43) Pub. Date: Feb. 19, 2009

(54) SHOCK ELIMINATING SHEET AND ELECTRONIC APPLIANCE MAKING USE OF THE SAME

(75) Inventors: Hideki Kuwajima, Fukui (JP); Tsutomu Mitani, Hyogo (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/095,979

(22) PCT Filed: Jun. 5, 2006
(86) PCT No.: PCT/JP2006/311187

§ 371 Date: Jun. 3, 2008

(30) Foreign Application Priority Data
Dec. 12, 2005 (JP) 2005-357388

(51) Int. Cl. B32B 7/02; B32B 3/10

(52) U.S. Cl. 428/137; 428/212; 428/213

(57) ABSTRACT

The shock absorbing sheet has a first surface subjected to an impact load, and is formed of first shock absorbing material and second shock absorbing material. The second shock absorbing material has a compressive elastic modulus larger than that of the first shock absorbing material and arranged in the first shock absorbing material. The second shock absorbing material is arranged so as to extend in the direction substantially orthogonal to the first surface. The cross-sectional area of the first shock absorbing material is equal to or larger than that of the second shock absorbing material in a cross-sectional area parallel to the first surface.

THIS APPLICATION IS A U.S. NATIONAL PHASE APPLICATION OF PCT INTERNATIONAL APPLICATION PCT/JP2006/311187.

### TECHNICAL FIELD

The present invention relates to a shock eliminating (absorbing) sheet and to an electronic appliance including the same, the sheet for absorbing shock to a disk-type recording and reproducing device (hereinafter referred to as “disk device”) for recording and reproducing information with a high density, such as a magnetic disk drive and optical disk drive, or to an electronic device used in a mobile environment.

### BACKGROUND ART

In recent years, with downsizing and weight reduction of electronic appliances in progress, an extremely large number of electronic appliances have been used in mobile environments. Such an electronic appliance is subject to an extremely strong shock more frequently due to a fall or the like while it has been carried. With further downsizing and weight reduction in progress, the drop height of an electronic appliance tends to increase, while it has been carried, thus its shock is still further enlarged.

To deal with the circumstances, a method is proposed in which a shock absorbing member such as a sponge cushion is bonded around an electronic appliance body, and then the electronic appliance body mounted to the containing case via the shock absorbing member. However, to effectively absorb an extremely strong shock due to a drop, as high as 10,000 G or higher for example, and to protect the electronic appliance body against fatal damage, the thickness of the shock absorbing member needs to be increased. As the thickness increases, the shock absorbing ability immediately after being subjected to a shock increases as well. However, the shock absorbing member deforms rapidly, and thus the elastic restorative force of the member increases rapidly. Accordingly, the buffering capacity rapidly decreases and the shock absorbing ability weakens, resulting in the electronic appliance body subjected to a relatively strong impactive force within a few moments. Meanwhile, as the thickness of the shock absorbing member increases, the electronic appliance including the electronic appliance body and the shock absorbing member enlarges. As a result, downsizing becomes difficult.

To solve these problems, Japanese Patent Unexamined Publication No. H11-242881 proposes using two types of shock absorbing members with different elastic deformation rates. In this solution, the thickness of the hard second shock absorbing member is set to roughly the same thickness at which the shock absorbing effect owing to the compression of the soft first shock absorbing member is lost.

For a weak shock, only the soft first shock absorbing member absorbs the shock softly; for a strong one, the second shock absorbing member absorbs the shock that the first member fails to absorb. Each shock absorbing member thus absorbs shock by its elastic deformation. This composition can effectively handle a wide range of shock, from weak to strong, compared to that with a single shock absorbing member. In such a composition, the hard second shock absorbing member as well absorbs shock simply by elastic deformation. However, even in such a composition, it is difficult to effectively absorb an extremely strong drop shock, as high as 10,000 G or higher for example, to protect the electronic appliance body against fatal damage.

Further, Japanese Patent Unexamined Publication No. 2004-315087 discloses a technique for improving impact resistance dramatically. The technique is described using FIGS. 11A, 11B. FIG. 11A is a sectional view of an appliance with a built-in electronic device such as a disk device. FIG. 11B is a schematic perspective view of a shock absorbing member used for the appliance.

As shown in FIG. 11B, shock absorbing member 1118 is structured so that shock absorbing substrate 1118A and shock absorbing soft part 1118B are combined piece by piece. Then, as shown in FIG. 11A, electronic appliance 1117 (e.g. disk device) is contained in device 1119 via shock absorbing member 1118. In this structure, for a weak shock exerted on device 1119, shock absorbing soft part 1118B absorbs the shock softly; for a strong one, shock absorbing substrate 1118A absorbs the shock. For a further stronger one that substrate 1118A fails to absorb, substrate 1118A breaks to absorb the shock, thereby absorbing an extremely strong drop shock, as high as 10,000 G or higher for example.

However, for a strong shock exceeding the shock absorbing performance of this structure, electronic appliance 1117 is assumed to be damaged. Further, shock absorbing members 1118 formed of plural pieces need to be arranged in spaces between electronic appliance 1117 and device 1119. Accordingly, a troublesome process is required in which individual shock absorbing members 1118 are attached to electronic appliance 1117.

### SUMMARY OF THE INVENTION

The present invention provides a shock absorbing sheet that prevents a strong shock from transmitting to the device body to protect it against fatal damage even when the device is subjected to an extremely strong shock such as a fall, and an electronic appliance including the shock absorbing sheet. The shock absorbing sheet of the present invention has a first surface subjected to an impact load and is formed of a first shock absorbing material and a second shock absorbing material. The second shock absorbing material has a compressive elastic modulus larger than that of the first one and is arranged in the first one. The second shock absorbing material is arranged so as to extend substantially orthogonally to the first surface, where the cross-sectional area of the first shock absorbing material is equal to or larger than that of the second one, in a cross section parallel to the first surface. With this structure, the shock absorbing sheet can bear an impulsive compressive force over a relatively long time even when it is subjected to an extremely strong shock. Consequently, an electronic appliance body with this shock absorbing sheet provided therearound is subjected to an extremely small shock, thereby protecting the electronic appliance body against fatal damage. The electronic appliance according to the present invention includes the electronic appliance body and the above-described shock absorbing sheet provided therearound to provide a superior shock absorbing performance.

### BRIEF DESCRIPTION OF DRAWINGS

FIG. 1 is a schematic sectional view illustrating a structure of an electronic appliance according to an embodiment of the present invention.

FIG. 2A is a perspective view of a shock absorbing member forming a shock absorbing sheet according to the embodiment of the present invention.

FIG. 2B is a perspective view showing the structure of the shock absorbing sheet formed of the shock absorbing members in FIG. 2A, which are arranged in close contact with each other.

FIG. 2C is a side view showing a process of absorbing shock by the shock absorbing sheet according to the embodiment of the present invention.

FIG. 2D is a side view showing a process of absorbing shock by another shock absorbing sheet according to the embodiment of the present invention.

FIG. 3 illustrates an example method of manufacturing the shock absorbing sheet according to the embodiment of the present invention.

FIG. 4A schematically shows the shock absorbing member according to the embodiment of the present invention.

FIG. 4B shows a state where the shock absorbing member schematically shown in FIG. 4A is operated.

FIG. 4C is a graph showing temporal changes of an impact load exerted on the shock absorbing member schematically shown in FIG. 4A, and the temporal change rate of the impact resistance of the member.

FIG. 5A is a schematic side view showing an example method of examining the shock absorbing effect of a conventional shock absorbing member in a conventional arrangement.

FIG. 5B is a schematic side view showing an example method of examining the shock absorbing effect of a conventional shock absorbing member in the same arrangement as that of the embodiment of the present invention.

FIG. 5C is a schematic side view showing an example method of examining the shock absorbing effect of a conventional sheet-like shock absorbing member in a conventional arrangement.

FIG. 5D is a schematic side view showing an example method of examining the shock absorbing effect of a shock absorbing member according to the embodiment of the present invention in an arrangement of the embodiment of the present invention.

FIG. 6 is a schematic sectional view illustrating the structure of another electronic appliance according to the embodiment of the present invention.

FIG. 7A is a perspective view showing another structure of the shock absorbing sheet according to the embodiment of the present invention.

FIG. 7B is a perspective view shows a state where a stay bar is inserted into the shock absorbing member shown in FIG. 7A.

FIG. 8 is a sectional view showing another structure of the shock absorbing sheet according to the embodiment of the present invention.

FIG. 9 is a transparent perspective view showing yet another structure of the shock absorbing sheet according to the embodiment of the present invention.

FIG. 10 is a perspective view showing still another structure of the shock absorbing sheet according to the embodiment of the present invention.

FIG. 11A is a schematic sectional view illustrating the structure of a disk device with a conventional shock eliminating structure.

FIG. 11B is a perspective view of the conventional shock absorbing member shown in FIG. 11A.

### DETAILED DESCRIPTION OF PREFERRED EMBODIMENT

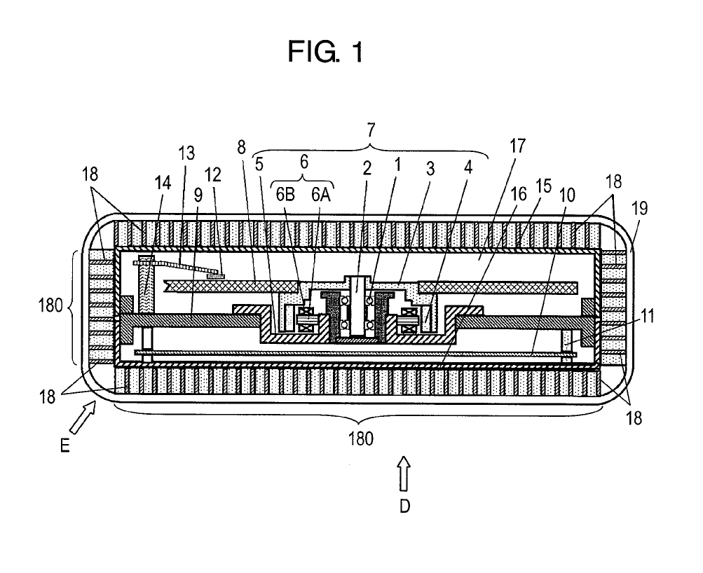

FIG. 1 is a schematic sectional view illustrating a structure of an electronic appliance according to the embodiment of the present invention. Hereinafter, a description is made by instancing a magnetic disk drive as an electronic appliance.

Bearing 1 rotatably supports rotation axis 2. Rotor hub 3 is fastened to rotation axis 2. Rotor hub 3 has rotating magnet 4, which is magnetized to plural magnetic poles and fastened at its outer peripheral bottom end surface by a widely known method such as press-fitting, bonding, or other method. Motor chassis 5 has stator 6 fixed thereto so that stator 6 faces the inner peripheral surface of rotating magnet 4. Stator 6 has a structure in which stator core 6A with plural pole teeth and each pole tooth has coil 6B coiled therearound. A current supplied to coil 6B causes rotating magnet 4 to generate a rotary drive force, thus rotating rotor hub 3. In this way, spindle motor 7 is structured. The top surface of the flange of rotor hub 3 has magnetic disk 8 placed thereon. Magnetic disk 8 rotates following the rotation of rotor hub 3.

Spindle motor 7 with magnetic disk 8 mounted thereon is fixed to substrate 9. Circuit substrate 10 is fixed to lower inner case 16 through support member 11. Circuit substrate 10 has a circuit for rotatably driving spindle motor 7 and for controlling the rotation; and an electronic circuit required as the apparatus, such as a signal processing circuit for recording or reproducing signals on magnetic disk 8, incorporated thereinto. Suspension 13 is fixed to substrate 9 through column 14. Suspension 13 is a swing portion for positioning magnetic head 12 to a given track location. Magnetic head 12 is disposed facing the top surface of magnetic disk 8. Magnetic head 12 is a signal conversion element for recording or reproducing signals on magnetic disk 8.

At the end edge of substrate 9, for example, the part bent upward or downward of substrate 9 has upper inner case 15 and lower inner case 16 fixed thereto. Upper inner case 15 and lower inner case 16 form the outer shell of magnetic disk drive body 17, namely the electronic appliance body. Magnetic disk drive body 17 is thus structured.

Shock absorbing members 18 arranged in a sheet-like shape are fastened corresponding to six surfaces outside magnetic disk drive body 17. That is, shock absorbing sheet 180 is provided around magnetic disk drive body 17. Shock absorbing member 18 touches the inside of outer case 19 arranged outside magnetic disk drive body 17. The magnetic disk drive is thus structured. Magnetic disk drive body 17 is not necessarily required to be enclosed with upper inner case 15 and lower inner case 16, but shock absorbing member 18 may be directly fastened to substrate 9 processed by a bending work or the like.

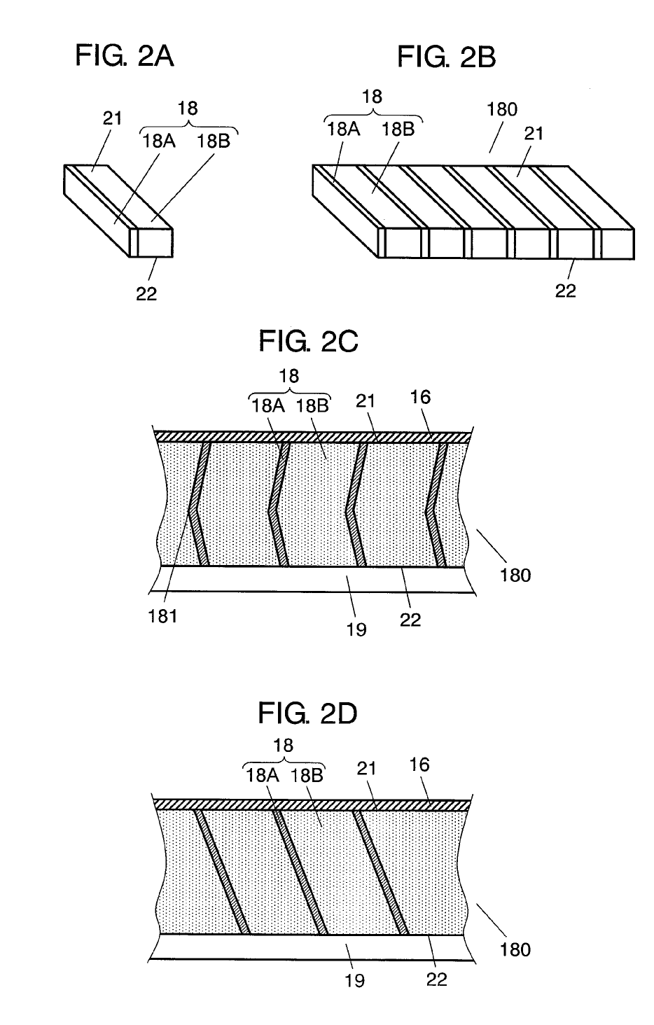

Next, shock absorbing member 18 and shock absorbing sheet 180 are described by using FIGS. 2A, 2B. FIG. 2A is a perspective view of a shock absorbing member used for a magnetic disk drive, which is an electronic appliance according to the embodiment of the present invention. FIG. 2B is a perspective view showing the structure of shock absorbing sheet 180, which is formed of shock absorbing members 18 in FIG. 2A arranged in close contact with each other.

Shock absorbing member 18 is produced by cutting a sheet of shock absorbing material (first shock absorbing material 18B and second shock absorbing material 18A alternately laminated) into pieces with a given size. Second shock absorbing material 18A is a shock absorbing substrate such as a typical polyethylene sheet. First shock absorbing material 18B is a shock absorbing soft part formed with a shock absorbing member such as gel. That is, second shock absorbing material 18A has a compressive elastic modulus larger than that of material 18B and is arranged in material 18B. A compressive elastic modulus can be defined by JIS K 7181 of a JIS standard or the like.

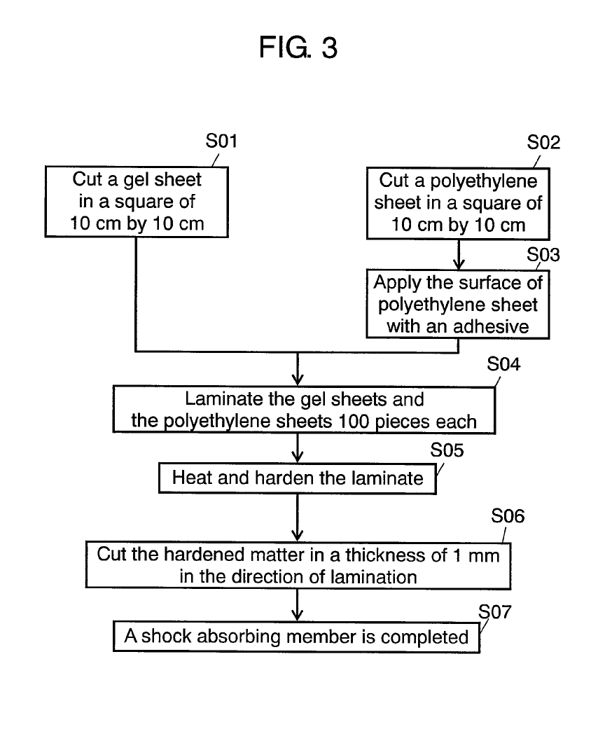

Here, a description is made for an example method of manufacturing shock absorbing member 18 (i.e. shock absorbing sheet 180) using FIG. 3. First shock absorbing material 18B is made of a gel sheet mainly containing silicone resin with a compressive elastic modulus (Young's modulus) of 119.5 kPa, a thickness of 2 mm. Second shock absorbing material 16A is made of a polyethylene sheet with a compressive elastic modulus of 7,200 kPa, a thickness of 0.5 mm.

First, the gel sheet is cut in a square of 10 cm by 10 cm (S01). Meanwhile, the polyethylene sheet is cut in a square of 10 cm by 10 cm as well (S02). Next, an adhesive of synthetic rubber is applied to the surface of the polyethylene sheet (S03). Then, the gel sheets and polyethylene sheets (by 100 pieces respectively) are laminated alternately (S04). This laminate is heated at 40° C. for 30 minutes, for example, to harden the adhesive (S05). After hardening, the laminate is cut in the direction of lamination in a thickness of 1 mm (S06). Shock absorbing sheet 180 is completed as discussed above (S07).

Second shock absorbing material 18A made of a polyethylene sheet, for example, has a certain degree of hardness. Consequently, when shock absorbing member 18 is pressed inward of the surface, second shock absorbing material 18A is bent and deformed. Meanwhile, first shock absorbing material 18B has cushioning characteristics like a rubber material. Consequently, when shock absorbing member 18 is pressed, first shock absorbing material 18B is compressively deformed. That is, the compressive elastic modulus of second shock absorbing material 18A is larger than that of material 18B. Shock absorbing member 18 is thus a combination of second shock absorbing material 18A and first shock absorbing material 18B.

There are various kinds of combinations of materials for implementing desired magnitude correlation between the compressive elastic modulus of first shock absorbing material 18B and that of second shock absorbing material 18A. For example, as first shock absorbing material 18B, a typical gel material such as silicone gel, or a rubber material such as natural rubber or synthetic rubber can be used. Meanwhile, as second shock absorbing material 18A, polyethylene terephthalate (PET), polynaphthalene terephthalate (PEN), polytetrafluoroethylene (PTFE), polycarbonate or the like is used.

Shock absorbing sheet 180 has end surfaces 21, 22 opposite to each other at its both longitudinal sides, perpendicularly to the overlapped surfaces of second shock absorbing material 18A and first shock absorbing material 18B in FIG. 2A integrally-molded. End surface 22 is a first surface subjected to an impact load, and end surface 21 is a second surface opposite to the first one. Then, as shown in FIG. 1, shock absorbing sheet 180 is placed between outer case 19 and upper inner case 15 or lower inner case 16. That is, shock absorbing sheet 180 is placed between magnetic disk drive body 17 and outer case 19. Then, end surfaces 21, 22 are arranged so as to touch the outer surface of magnetic disk drive body 17 and the inner surface of outer case 19, respectively. Shock absorbing sheet 180 is thus integrally molded by laminating second shock absorbing material 18A with a certain degree of hardness and first shock absorbing material 18B extremely soft with cushioning characteristics.

Shock absorbing sheet 180 is formed by first shock absorbing material 18B and second shock absorbing material 18A with the equal thickness as a layer respectively, and arranged alternately laminated substantially orthogonally to end surfaces 21, 22. Otherwise, first shock absorbing material 18B may be different from second shock absorbing material 18A in thickness. In this case, first shock absorbing material 18B is desirably equal to or larger than second shock absorbing material 18A in the average thickness in the direction of lamination. In other words, it is adequate as long as second shock absorbing material 18A is arranged so as to extend substantially orthogonally to end surfaces 21, 22, and the cross-sectional area of first shock absorbing material 18B is equal to or larger than that of second shock absorbing material 18A, in a cross section parallel to end surfaces 21, 22. In FIG. 2B, because the end of second shock absorbing material 18A is exposed at end surfaces 21, 22, it is adequate as long as the area of first shock absorbing material 18B is equal to or larger than that of second shock absorbing material 18A at end surfaces 21, 22.

When the average thickness of second shock absorbing material 18A is larger than that of first shock absorbing material 18B, the effect of first shock absorbing material 18B as cushioning material becomes difficult to appear. In this case, shock absorbing sheet 180 is practically formed of only hard second shock absorbing material 18A, thereby reducing the shock absorbing effect. Hence first shock absorbing material 18B and second shock absorbing material 18A preferably have the above-described dimensions.

Both second shock absorbing material 18A and first shock absorbing material 18B are subjected to shock in parallel. Here, the thickness of the shock absorbing part of shock absorbing member 18 is preferably an appropriate one. For shock immediately after being subjected to an extremely strong impact, this arrangement allows second shock absorbing material 18A with a certain degree of hardness and first shock absorbing material 18B with cushioning characteristics to be subjected to the shock in parallel. Here, the thickness of the shock absorbing part of shock absorbing member 18 is the distance between end surface 21 and end surface 22.

Next, changes of second shock absorbing material 18A, which has been subjected to shock, are described by using FIG. 2C. FIG. 2C is a side view showing a process of absorbing shock by the shock absorbing sheet according to the embodiment of the present invention.

For shock immediately after being subjected to an extremely strong impact, second shock absorbing material 18A mainly bears the shock. Next, second shock absorbing material 18A bends at bend portion 181 halfway. That is, second shock absorbing material 18A has bend portion 181 bending and deforming in parallel to end surface 22 when a load is exerted on end surface 22. Then, second shock absorbing material 18A buckles at bend portion 181 near an intermediate part due to the unbearable impulsive compressive force.

After that, the repulsive force of second shock absorbing material 18A against the compressive force gradually decreases, and first shock absorbing material 18B with cushioning characteristics mainly absorbs the impactive force. In FIG. 2C, the example is shown where all the directions in which second shock absorbing materials 18A bend are the same. However, second shock absorbing material 18A can have a bend portion bending randomly in different directions. In this case, a compressed part and expanded part are occurred in second shock absorbing material 18A, and both of them exhibit a resistant effect against the impactive force, thereby further exhibiting an effect of the impact resistance.

FIG. 2D is another side view of a process of absorbing shock by shock absorbing sheet 180, and shows another change of second shock absorbing material 18A in a case where it is subjected to shock. In this case, second shock absorbing material 18A does not buckle, but is down to the left in the figure. In other words, second shock absorbing material 18A is tilted in parallel to end surface 22. In this case as well, for outer case 19, the same effect as a case of buckling is obtained from a vertical state to a down state of second shock absorbing material 18A.

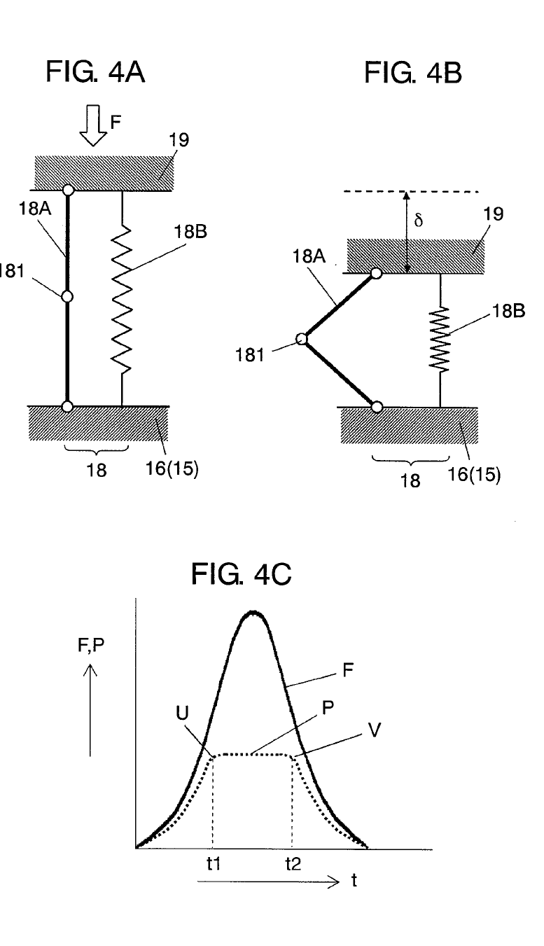

FIG. 4A schematically shows an operation of shock absorbing member 18 formed of second shock absorbing material 18A and first shock absorbing material 18B. Outer case 19 and lower inner case 16 (or upper inner case 15) are disposed in parallel to each other. Second shock absorbing material 18A is shown by a bold solid line regarded as a rigid body with bend portion 181 as a link. First shock absorbing material 18B is depicted as a spring. FIG. 4B shows a state where impact load F is exerted from outer case 19.

FIG. 4C is a graph showing changes at time t of impact load F exerted on shock absorbing member 18, and temporal change rate P of the impact resistance of shock absorbing member 18. When outer case 19 is subjected to extremely strong impact load F due to a fall of the apparatus, first both second shock absorbing material 18A (e.g. like a planar spring bent) and first shock absorbing material 18B (e.g. like a rubber member compressed) elastically deform. Consequently, temporal change rate P of the impact resistance changes roughly along impact load F to point U at time to in FIG. 4C. When impact load F exceeds limit of the linear elastic deformation of second shock absorbing material 18A, second shock absorbing material 18A (i.e. a rigid body) flexes at bend portion 181 and starts to bend. This is considered that second shock absorbing material 18A deforms so as to bend with bend portion 181 as a link. In this flexural deformation, temporal change rate P of the impact resistance of second shock absorbing material 18A proceeds remaining virtually constant to reach point V at time t2 in FIG. 4C.

When impact load F further increases and exceeds the limit of bending due to the flexural deformation of second shock absorbing material 18A, second shock absorbing material 18A buckles at bend portion 181 near the intermediate part due to the unbearable impulsive compressive force. That is, as shown in FIG. 2C, second shock absorbing material 18A bends at bend portion 181. As shown in FIG. 4B, this is considered that second shock absorbing material 18A deforms so as to bend with bend portion 181 as a link. At this moment, shock absorbing member 18 becomes a compressed shape by deformation volume δ. Shock absorbing member 18 thus absorbs impact load F.

After that, the repulsive force of second shock absorbing material 18A against the compressive force gradually decreases. Then, first shock absorbing material 18B with cushioning characteristics mainly absorbs impact load F. Consequently, temporal change rate P of the impact resistance gradually decrease as shown on the right side of point V in FIG. 4C.

The state, where shock absorbing member 18 is subjected to impact load F and temporal change rate P of the impact resistance proceeds from point U to point V, is similar to a case where a heavy object is lifted with a mechanical jack. That is, the process, in which an extremely strong force is first required, corresponds to that from the point at which an impact load is exerted in FIG. 4C, to point U. Then, the process, in which the object becomes light and can be operated with a small force after being lifted to a certain level, corresponds to that from point U to point V in FIG. 4C.

As described above, shock absorbing sheet 180 is integrally formed of second shock absorbing material 18A formed with material having a certain degree of hardness and additionally flexibility; and first shock absorbing material 18B formed with extremely soft material having cushioning characteristics. When an extremely strong shock is exerted, second shock absorbing material 18A bends at bend portion 181 in the intermediate part and absorbs the impactive force by further buckling. To reliably perform buckling at bend portion 181, when an extremely strong shock is exerted, the intermediate part (bend portion 181) of second shock absorbing material 18A may be provided with at least one of a hole, a cut, and a notch.

Second shock absorbing material 18A does not need to be exposed at end surfaces 21, 22. Even when it is not exposed, a shock absorbing effect by second shock absorbing material 18A is achieved if second shock absorbing material 18A bridges between end surfaces 21 and 22 when first shock absorbing material 18B is compressively deformed. However, if both ends of second shock absorbing material 18A are exposed at end surfaces 21, 22, a shock absorbing effect by second shock absorbing material 18A is achieved more strongly compared to the case where they are not exposed at the end surfaces, thus it is preferable.

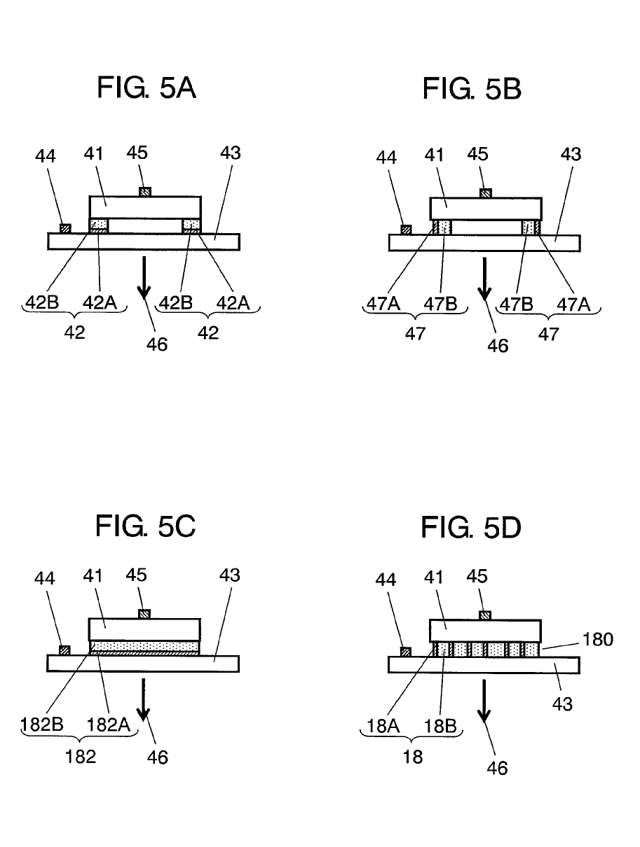

Next, the effect of shock absorbing sheet 180 is described by showing the experimental result. The experiment is performed using the structures shown in FIGS. 5A through 5D.

In the structure shown in the side view of FIG. 5A, second shock absorbing material 42A of conventional shock absorbing member 42 is bonded to the outer side surface of simulator 41, which corresponds to magnetic disk drive body 17 in FIG. 1. First shock absorbing material 42B is bonded to the surface opposite to that the surface of second shock absorbing material 42A bonded to the outer side surface of simulator 41. Second shock absorbing material 42A and first shock absorbing material 42B are thus arranged in series along the impact load direction. More specifically, base 43 corresponding to outer case 19 in FIG. 1, second shock absorbing material 42A, first shock absorbing material 42B, and simulator 41 are stacked in this sequence. Here, even when second shock absorbing material 42A and first shock absorbing material 42B are stacked in the reverse order, the same result is achieved.

In the structure shown in the side view of FIG. 5B, second shock absorbing material 47A and first shock absorbing material 47B of conventional shock absorbing member 47 are arranged in parallel to the impact load direction.

In the structure shown in the side view of FIG. 5C, second shock absorbing material 182A of conventional shock absorbing member 182 is bonded to the outer side surface of simulator 41. The other surface of second shock absorbing material 182A has first shock absorbing material 182B bonded thereto. Second shock absorbing material 182A and first shock absorbing material 182B are thus arranged in series along the impact load direction.

In the structure shown in the side view of FIG. 5D, second shock absorbing material 18A and first shock absorbing material 18B of shock absorbing member 18 according to the present invention are arranged in parallel to the impact load direction. Shock absorbing sheet 180 is thus arranged. Here, the heights of shock absorbing members 42, 47, 182, 18, namely the distance between base 43 and simulator 41, are all set equally.

In this way, the difference in shock absorption is examined for the four types. Hereinafter, the experimental method is briefly described. The top surface of base 43 has accelerometer 44 attached thereon. The top surface of simulator 41 has accelerometer 45 attached thereon. Then, the temporal change in shock absorption is recorded using values measured by respective accelerometers 44, 45 when base 43 free-falls from a height of 100 cm in the direction of arrow 46. Table 1 shows the result obtained.

TABLE 1

| | | | Impact |
|---|---|---|---|
| Experiment | Reference | Maximum | time |
| No. | FIGURE | impact value (G) | (ms) |
| 0 | (on the base) | 8,000 | 2.71 |
| 1 | FIG. 5A | 2,200 | 0.94 |
| 2 | FIG. 5B | 1,200 | 1.46 |
| 3 | FIG. 5C | 1,600 | 0.90 |
| 4 | FIG. 5D | 800 | 1.24 |

Table 1 shows the respective maximum impact values and impact times determined by the graph recording G values output from accelerometers 45, 48. The impact time is time from when the impact starts until when the amplitude decreases to 10 G or lower in each graph. The maximum impact value and impact time according to accelerometer 44 attached to the top surface of base 43 are average values of data obtained in the four types of structures.

In the structures shown in FIGS. 5A, 5C, first shock absorbing materials 42B, 182B and second shock absorbing materials 42A, 182A are arranged in series along the impact load direction (experiment No. 1, 3). In these structures, the shock absorbing performance of first shock absorbing material 42B, 182B effectively works immediately after being subjected to shock, and thus exhibiting shock absorbing performance at an early stage. Accordingly the shock period is short. However, if it is subjected to an extremely strong impactive force, first shock absorbing materials 42B, 182B are largely and compressively deformed, thereby increasing the elastic repulsive force with time. Consequently, the value of the maximum impact exerted on simulator 41 increases as well. Finally, the situation becomes almost the same as that of rigid bonding, and what is called “bottoming-out phenomenon” occurs, thus a shock absorbing effect can hardly occur.

Meanwhile, in the structures shown in FIGS. 5B, 5D, first shock absorbing materials 47B, 18B and second shock absorbing materials 47A, 18A are arranged in parallel (experiment No. 2, 4). In these structures, second shock absorbing materials 47A, 18A and first shock absorbing materials 47B, 18B are subjected to a compressive force in parallel immediately after being subjected to an impulsive compressive force. Then, the elastic repulsive force of second shock absorbing materials 47A, 18A mainly becomes a bearing force against the compression. When the impact value further increases, second shock absorbing materials 47A, 18A buckle due to the unbearable compressive force, and the compression repulsive force of second shock absorbing materials 47A, 18A gradually decreases. Then, instead of second shock absorbing materials 47A, 18A, first shock absorbing materials 47B, 18B are subjected to the compressive force. Shock absorbing members 47, 18 can thus bear an impulsive compressive force over a longer time than the conventional method where the first shock absorbing material and second shock absorbing material are arranged in series along the impact load direction as in shock absorbing members 42, 182. As a result, the effect of absorbing an impactive force drastically increases. Further, shock absorbing member 18 according to the embodiment of the present invention absorbs shock over a larger area than shock absorbing member 47 does, and thus this shock absorbing effect appears more prominently. The cause of the difference between the result (experiment No. 1, 2) of conventional shock absorbing members 42, 47 shown in FIGS. 5A, 5B; and that (experiment No. 3, 4) of shock absorbing members 182, 18 shown in FIGS. 5C, 5D is assumed to be that shock absorbing members 182, 18 are sheet-like and receive shock with a flat surface. This further increases the shock absorbing performance. When the structure shown in FIG. 5D is used to an application where the shock absorbing performance nearly equal to that of the structure shown in FIG. 5B is sufficient, material with a compressive elastic modulus smaller than that of second shock absorbing material 47A can be used for second shock absorbing material 18A. This increases the number of choices of material from the viewpoint other than shock absorbing such as material cost or fire retardancy.

In the structure of FIG. 5D according to the embodiment of the present invention, second shock absorbing material 18A and first shock absorbing material 18B are laminated substantially orthogonally to the impact load direction to compose shock absorbing member 18. Further, shock absorbing member 18 composes shock absorbing sheet 180. With such a composition and arrangement, the value of the maximum impact exerted on simulator 41 is 800 G, which is one tenth of that of the structure (experiment No. 0) without shock absorbing member 18 used. This is approximately 36% to 50% of the conventional structure. The impact time decreases to less than half the time exerted on base 43. These show the effectiveness of shock absorbing member 18 in parallel used.

Such a shock absorbing process occurs in either direction of shock, arrow D or arrow E in FIG. 1, which means the same effect is achieved in either direction of shock.

The above description is premised on the structure shown in FIG. 1. More specifically, the six surfaces outside magnetic disk drive body 17 enclosed by upper inner case 15 and lower inner case 16 have shock absorbing sheet 180, which is formed of plural shock absorbing members 18, fastened respectively corresponding to the surfaces. Then, plural shock absorbing members 18 are arranged in a roughly uniform density. However, the arrangement of shock absorbing member 18 is not limited to this example, but the arrangement density can be changed.

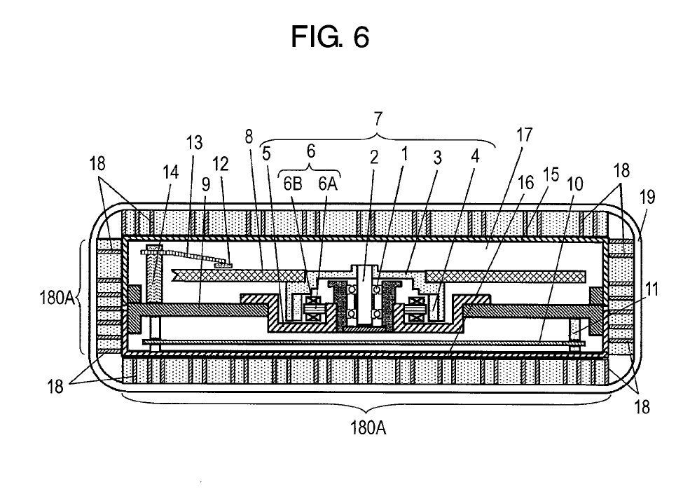

FIG. 6 is a schematic sectional view of shock absorbing member 18, with its arrangement changed. The weight of an electronic appliance is hardly allocated evenly, and a weight concentrated part is present. Arranging second shock absorbing material 18A in a high density to the weight concentrated part brings about a stronger shock absorbing effect. That is, second shock absorbing material 18A is preferably arranged in a high density at a position where a large impact load occurs. Second shock absorbing material 18A is desirably arranged at a part of a heavy member in a high density; and second shock absorbing material 18A is desirably arranged at a part of a light member in a low density. For example, second shock absorbing material 18A is arranged in a high density at a position where support member 11 and substrate 9 directly fixed to upper inner case 15 and lower inner case 16. Shock absorbing sheet 180A is preferably structured in this way.

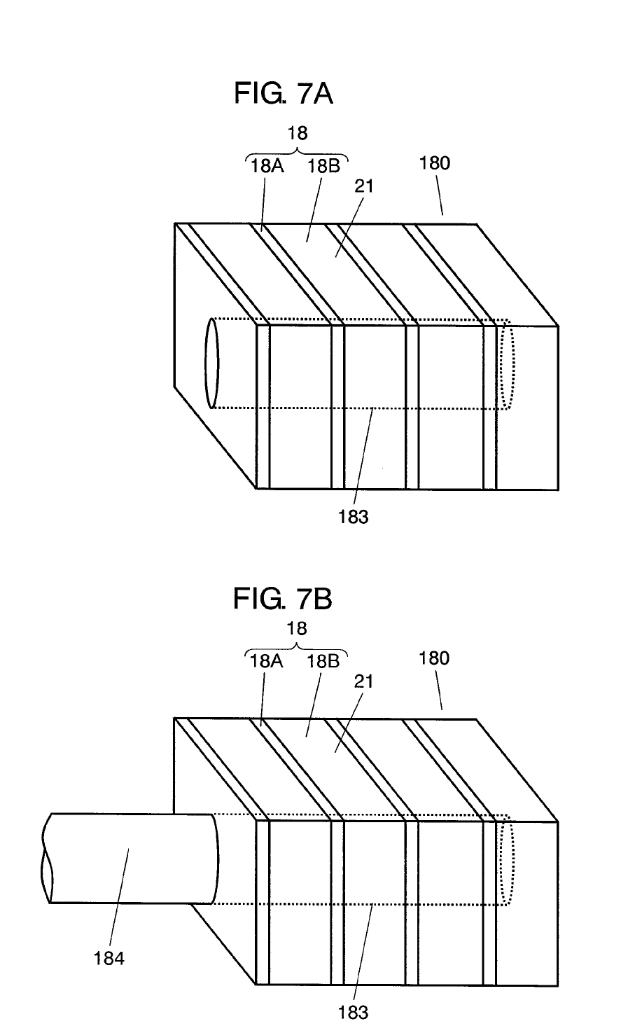

FIG. 2A shows shock absorbing member 18 in rectangular solid-shape. FIG. 2B shows a laminated structure of shock absorbing sheet 180 formed of plural shock absorbing members 18 in rectangular solid-shape arranged in close contact with each other, and integrally formed. However, the shape of the shock absorbing member of the present invention is not limited to this example. As exemplified in FIG. 7A, shock absorbing sheet 180 formed by laminating shock absorbing members 18 may be provided with hole 183 in its center. Further, as shown in FIG. 7B, stay bar 184, which is an extension portion extending from the main unit (not shown), may be inserted into hole 183 and fixed. In this case as well, the shock absorbing effect same as the above can be achieved.

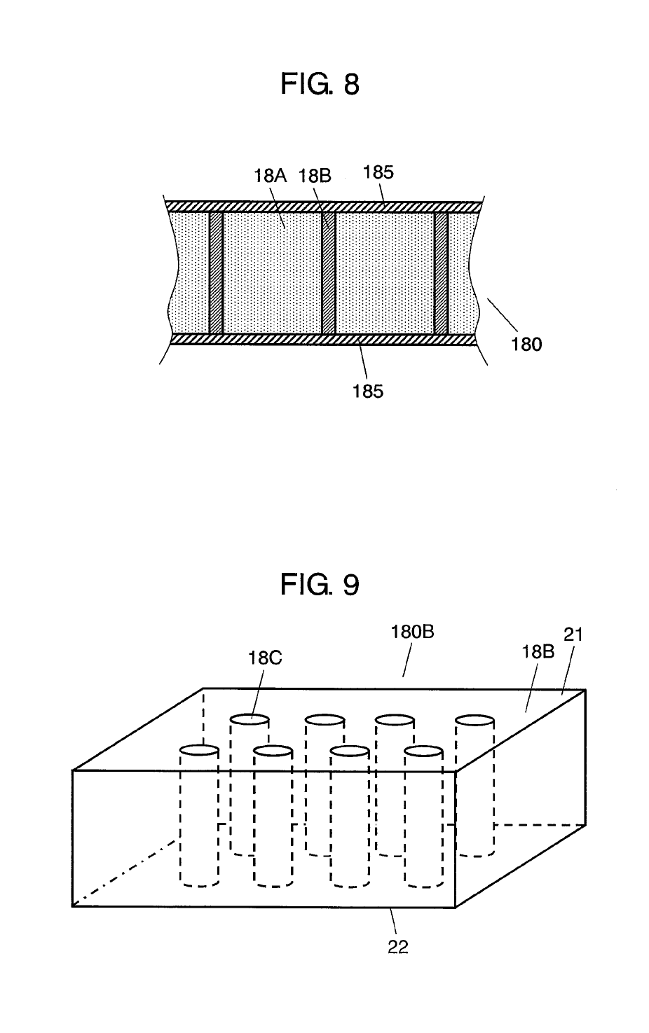

As shown in FIG. 2B, shock absorbing members 18 are arranged side by side to compose shock absorbing sheet 180. However, as shown in FIG. 8, shock absorbing sheet 180 may be sandwiched between base sheet 185. The structure, in which first shock absorbing material 18B and second shock absorbing material 18A are thus integrally formed, further simplifies handling shock absorbing sheet 180. Here, base sheet 185 made of thin material such as a polyethylene sheet is easily retained and fixed on base sheet 185 owing to its adhesiveness if first shock absorbing material 18B is made of gel material.

Furthermore, as shown in FIG. 9, second shock absorbing material 18C in cylinder-shape may be dispersively arranged in first shock absorbing material 18B, which is made of gel material, and compose shock absorbing sheet 180B. In this case, second shock absorbing material 18C is arbitrarily arranged so that the axis of the cylinder is substantially perpendicular to end surfaces 21, 22, or the radial direction is substantially parallel to end surfaces 21, 22. Shock absorbing sheet 180B can be produced in the following way, for example; a photosensitive organic sheet is used as first shock absorbing material 18B; an opening (through hole) is formed in this sheet by exposure and development; and second shock absorbing material 18C is formed by filling the opening with thermosetting organic resin material and then by thermally hardening the material.

Second shock absorbing material 18C with a compressive elastic modulus larger than that of first shock absorbing material 18B is arranged in first shock absorbing material 18B. Second shock absorbing material 18C may be arranged regularly at given intervals as shown in FIG. 9, or randomly without allowing large spacing. The average diameter of second shock absorbing material 18C is preferably smaller than its average arrangement interval. In other words, second shock absorbing material 18C is desirably arranged so as to extend in a direction substantially orthogonal to end surfaces 21, 22, and the cross-sectional area of first shock absorbing material 18B is equal to or larger than that of second shock absorbing material 18C, in a cross section parallel to end surfaces 21, 22. The reason for this is the same as that in the structure of FIG. 2B.

The diameter of cylinder-shaped second shock absorbing materials 18C may be all the same or may be different from each other. Further, second shock absorbing material 18C can be polygonal cylinder-shaped, semi-cylinder-shaped, or elliptic cylinder-shaped, besides cylinder-shaped. Even shock absorbing sheet 180, where second shock absorbing material 18C having a small external diameter and fibrous texture is arranged, can achieve the same shock absorbing effect as described above. Second shock absorbing material 18C shown in FIG. 9 often bends in a random direction.

Second shock absorbing material 18C does not need to be exposed at end surfaces 21, 22. Even if it is not exposed, a shock absorbing effect by second shock absorbing material 18C is achieved if second shock absorbing material 18C bridges between end surfaces 21 and 22 when first shock absorbing material 18B compressively deforms. However, if both ends of second shock absorbing material 18C are exposed at end surfaces 21, 22, a shock absorbing effect by second shock absorbing material 18C is achieved further stronger than they are not exposed at the end surface as above, thus it is preferable.

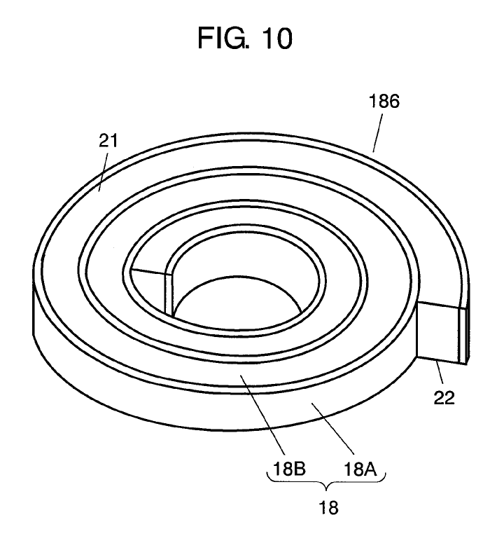

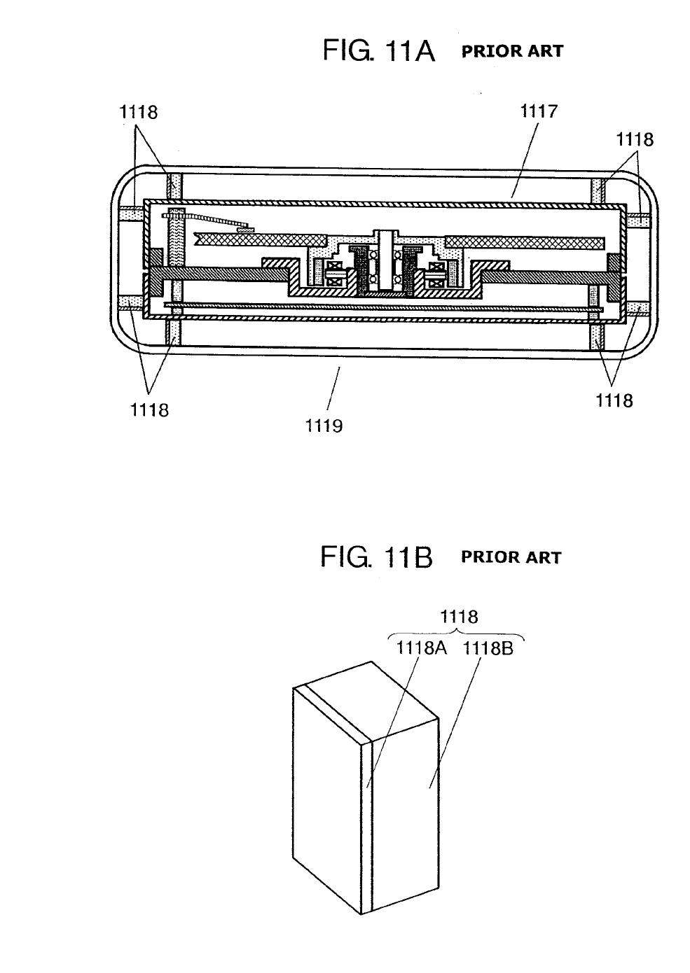

The structure shown in FIG. 10 may be used as well other than that where plural shock absorbing members 18 are arranged in a striped form like shock absorbing sheet 180 shown in FIG. 2B. In the structure shown in FIG. 10, one elongate shock absorbing member 18 formed of second shock absorbing material 18A and first shock absorbing material 18B is coiled spirally, thereby forming shock absorbing sheet 186. In other words, first shock absorbing material 18B and second shock absorbing material 18A are formed into a ribbon-like shape, laminated, and spirally coiled. Alternatively, plural shock absorbing members 18 formed of second shock absorbing material 18A and first shock absorbing material 18B circularly structured with different sizes, can be concentrically fastened, thereby forming a shock absorbing sheet with appearance like what is called a Baumkuchen.

In this case as well, second shock absorbing material 18A has a compressive elastic modulus larger than that of material 18B and arranged in material 18B. Second shock absorbing material 18A is arranged so as to extend in the direction substantially orthogonal to end surfaces 21, 22. The average thickness of first shock absorbing material 18B is equal to or larger than that of second shock absorbing material 18A. That is, the cross-sectional area of first shock absorbing material 18B is preferably equal to or larger than that of second shock absorbing material 18A in a cross section parallel to end surfaces 21, 22.

In this embodiment, magnetic disk drive 17 as an electronic appliance is described, but the present invention is not limited to this embodiment. The present invention is applicable to an optical disk drive, magneto optical disk drive, or other electronic appliances used in a mobile environment.

When an extremely strong impact load such that second shock absorbing materials 18A, 18C buckle to absorb the shock is exerted, the shock absorb performance of shock absorbing sheets 180, 180A, 180B, 186 becomes insufficient. For this reason, sensors for detecting that second shock absorbing materials 18A, 18C have buckled are preferably attached to shock absorbing sheets 180, 180A, 180B, 186 in this case. Further, a display system for encouraging replacement of shock absorbing sheets 180, 180A, 180B, 186 on the basis of a detecting signal of buckling is preferably provided on the electronic appliance.

### INDUSTRIAL APPLICABILITY

A shock absorbing sheet according to the present invention provides a small shock absorbing effect and a relatively large elastic repulsive force immediately after shock. Then, after a given time elapses, the elastic repulsive force is small and the shock absorbing effect increases. The shock absorbing sheet can further bear the impulsive compressive force over a relatively long time. Consequently, while an electronic appliance including this shock absorbing sheet is being carried, the appliance is not damaged fatally even when it is subjected to an extremely strong shock due to a fall or the like. The shock absorbing sheet is applicable to an information recording and reproducing device such as a disk device, and to a mobile electronic appliance or apparatus containing the device.

1. A shock absorbing sheet comprising:
a first surface subjected to an impact load;
a first shock absorbing material; and
a second shock absorbing material having a compressive elastic modulus larger than that of the first shock absorbing material, arranged in the first shock absorbing material, wherein
the second shock absorbing material is arranged so as to extend in a direction substantially orthogonal to the first surface, and wherein
a cross-sectional area of the first shock absorbing material is equal to or larger than a cross-sectional areas of the second shock absorbing material in a cross section parallel to the first surface.

2. The shock absorbing sheet according to claim 1, wherein
the first shock absorbing material is formed from a plurality of layers of the first shock absorbing material, and the second shock absorbing material is formed from a plurality of layers of the second shock absorbing material, and wherein
the layers of the first shock absorbing material and the layers of the second hock absorbing material are alternately laminated in a direction substantially orthogonal to the first surface, and an average thickness of the layers of the first shock absorbing material in a direction of the lamination is equal to or larger than that of the layers of the second shock absorbing material.

3. The shock absorbing sheet according to claim 1, wherein
the first shock absorbing material and the second shock absorbing material are formed into a ribbon-like shape, and the first shock absorbing material and the second shock absorbing material laminated have one of a structure in which they are spirally coiled, and a structure in which they are concentrically laminated and coiled, and wherein
an average thickness of the first shock absorbing material is equal to or larger than that of the second shock absorbing material.

4. The shock absorbing sheet according to claim 1, wherein
the second shock absorbing material is one of the plurality of second shock absorbing materials, and the plurality of second shock absorbing materials are dispersively arranged in the first shock absorbing material.

5. The shock absorbing sheet according to claim 1, wherein
the second shock absorbing material has a bend portion bending and deforming in a direction parallel to the first surface when the impact load is exerted on the first surface.

6. The shock absorbing sheet according to claim 5, wherein
the second shock absorbing material buckles at the bend portion.

7. The shock absorbing sheet according to claim 6, wherein
the bend portion is provided with at least one of a hole, a cut, and a notch.

8. The shock absorbing sheet according to claim 5, wherein
the second shock absorbing material is one of the plurality of second shock absorbing materials, and wherein
a direction of bending and deforming of at least one of the second shock absorbing materials is different from that of an other second shock absorbing material.

9. The shock absorbing sheet according to claim 1, wherein
the second shock absorbing material tilts in a direction parallel to the first surface when the impact load is exerted on the first surface.

10. The shock absorbing sheet according to claim 1, wherein
the first shock absorbing material and the second shock absorbing material are integrally formed.

11. The shock absorbing sheet according to claim 1, wherein
the shock absorbing sheet has a second surface opposite to the first surface, and both ends of the second shock absorbing material are exposed at the first surface and the second surface.

12. The shock absorbing sheet according to claim 1, wherein
the second shock absorbing material is one of the plurality of second shock absorbing materials, and wherein
the second shock absorbing materials are arranged in a high density at a position concentrically subjected to an external load.

13. An electronic appliance comprising:
an electronic appliance body; and
a shock absorbing sheet provided around the electronic appliance body, wherein
the shock absorbing sheet comprises:
a first surface subjected to an impact load;
a first shock absorbing material; and
a second shock absorbing material having a compressive elastic modulus larger than that of the first shock absorbing material, arranged in the first shock absorbing material, wherein
the second shock absorbing material is arranged so as to extend in a direction substantially orthogonal to the first surface, and wherein
a cross-sectional area of the first shock absorbing material is equal to or larger than a cross-sectional areas of the second shock absorbing material in a cross section parallel to the first surface.

14. The electronic appliance according to claim 13, wherein
the second shock absorbing material is arranged in a high density at a position where a weight of the electronic appliance body concentrates.

15. The electronic appliance according to claim 13, wherein
the electronic appliance body has an extension portion,
the shock absorbing sheet is provided with a hole for containing the extension portion, and
the extension portion is inserted into the hole and fixed.
